(19) United States
(12) Patent Application Publication
(10) Pub. No.: US 2026/0073541 A1
(43) Pub. Date: Mar. 12, 2026

(54) IMAGE PROCESSING METHOD USING GAZE INFORMATION AND ELECTRONIC DEVICE IMPLEMENTING THE SAME

(71) Applicant: SAMSUNG ELECTRONICS CO., LTD., Suwon-si (KR)

(72) Inventors: Bao HE, Beijing (CN); Weiming LI, Beijing (CN); Qiang WANG, Beijing (CN); Soonyong CHO, Beijing (CN); Younghun SUNG, Beijing (CN)

(73) Assignee: SAMSUNG ELECTRONICS CO., LTD., Suwon-si (KR)

(21) Appl. No.: 19/259,865

(22) Filed: Jul. 3, 2025

(30) Foreign Application Priority Data
Jul. 3, 2024 (CN) 202410882639.0
Nov. 15, 2024 (KR) 10-2024-0163344

(51) Int. Cl. G06T 7/55; G06F 3/01

(52) U.S. Cl. CPC G06T 7/55; G06F 3/013; G06T 2207/10024; G06T 2207/20084; G06T 2207/20221

(57) ABSTRACT

A method includes obtaining a first image, where the first image includes an RGB image and a first depth image as components of the first image, obtaining at least two image regions by processing the first image through an artificial intelligence (AI) network based on gaze point information, and obtaining a second depth image based on the at least two image regions, where, in the at least two image regions, image qualities of respective image regions are different, and a resolution of the first depth image is lower than a resolution of the second depth image.

### CROSS-REFERENCE TO RELATED APPLICATIONS

This application is based on and claims priority to Chinese Patent Application No. 202410882639.0, filed on Jul. 3, 2024, in the China National Intellectual Property Administration, and Korean Patent Application No. 10-2024-0163344, filed on Nov. 15, 2024, in the Korean Intellectual Property Office, the disclosures of which are incorporated by reference herein in their entireties.

### BACKGROUND

### 1. Field

The disclosure relates to the field of artificial intelligence (AI) technology, and more particularly, to an image processing method using gaze information and an electronic device implementing the same.

### 2. Description of Related Art

Augmented reality technology provides a user with a realistic information experience by adding virtual content to a real scene in front of the user. In a three-dimensional space, an augmented reality system must process and understand in real time a three-dimensional state of surrounding objects with high accuracy to implement a high-quality virtual reality fusion effect in front of a user.

In the related art, an augmented reality system typically predicts an entire image to obtain a depth image with high accuracy. However, the processing of the above method may obtain a processing result with high accuracy, but an amount of computation is very large and processing complexity is very high.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Additional aspects will be set forth in part in the description which follows and, in part, will be apparent from the description, or may be learned by practice of the presented embodiments of the disclosure.

According to an aspect of the disclosure, a method may include obtaining a first image, where the first image includes an RGB image and a first depth image as components of the first image, obtaining at least two image regions by processing the first image through an artificial intelligence (AI) network based on gaze point information, and obtaining a second depth image based on the at least two image regions, where, in the at least two image regions, image qualities of respective image regions may be different, and a resolution of the first depth image may be lower than a resolution of the second depth image.

The at least two image regions may include a first image region obtained based on an image feature of a first region in the first image centered on a gaze point, a second image region obtained based on an image feature of a second region in the first image centered on the gaze point, where a pixel size of the second region may be greater than a pixel size of the first region, and a third image region obtained based on an image feature of the first image.

The obtaining of the at least two image regions may include obtaining a first image region by processing, through a first network, a first region in the first image that is determined based on the gaze point information, and obtaining at least one second image region by processing, through a second network, a region in the first image other than the first region, where the second network may include a partial network structure of the first network.

The obtaining of the at least two image regions comprises may include a shallow feature of the first image, obtaining at least one image region by performing feature reconstruction on the shallow feature, obtaining, based on the shallow feature, a deep feature of a first region in the first image that is determined based on the gaze point information, and obtaining a first image region by performing feature reconstruction on the deep feature.

The obtaining of the at least two image regions may include obtaining a first shallow feature of the first image, obtaining a third image region by performing feature reconstruction of the first shallow feature, obtaining, based on the first shallow feature, a second shallow feature of a second region in the first image that is determined based on the gaze point information, and obtaining a second image region by performing feature reconstruction on the second shallow feature, where a pixel size of the second region may be greater than a pixel size of the first region.

The AI network may include a third network and a fourth network connected in parallel, where the third network may include a first network layer configured to obtain a high frequency feature within the RGB image, and a second network layer connected to the first network layer and configured to aggregate features output by previous levels, where the fourth network may include a third network layer configured to fuse a depth feature of the first depth image and a high frequency feature output by the third network, and a fourth network layer connected to the third network layer and configured to aggregate features output by previous levels, and where the obtaining of the at least two image regions may include obtaining, through the third network and based on the RGB image, high frequency features of at least two regions that are determined based on the gaze point information, where the high frequency features may include features representing detail information and/or boundary information, obtaining, through the fourth network, a first fusion feature corresponding to each of the at least two regions, based on depth features of the at least two regions in the first depth image that are determined based on the high frequency features and the gaze point information, and obtaining the at least two image regions by performing feature reconstruction for the first fusion feature corresponding to each of the at least two regions.

The obtaining of the first fusion feature may include obtaining a second fusion feature by performing feature fusion, based on the high frequency features output by a previous level of the third network and the depth features output by a previous level of the fourth network, obtaining a third fusion feature by performing multi-scale feature fusion, based on the second fusion feature, and obtaining the first fusion feature, based on the high frequency features output by the third network of the previous level, the depth features output by the fourth network of the previous level, and the third fusion feature.

The obtaining of the second fusion feature may include obtaining a first modulation feature by performing feature modulation based on the high frequency features output by the third network of the previous level and the depth features output by the fourth network of the previous level, obtaining a second modulation feature by performing feature modulation based on the first modulation feature and the depth features output by the fourth network of the previous level, and obtaining the second fusion feature based on the depth features output by the fourth network of the previous level and the second modulation feature.

The obtaining of the third fusion feature may include obtaining a multi-scale fusion feature by performing multi-scale feature processing based on the second fusion feature, generating an attention coefficient, based on the second fusion feature, obtaining a fusion feature related to attention based on the multi-scale fusion feature and the attention coefficient, and obtaining the third fusion feature based on the fusion feature related to attention and the second fusion feature,

The obtaining of the multi-scale fusion feature may include obtaining a feature by performing feature extraction through at least two dilated convolution layers based on the second fusion feature, and obtaining the multi-scale fusion feature by merging features corresponding to respective dilated convolution layers.

The method may include obtaining a virtual object, and obtaining a third image comprising the virtual object based on the RGB image and the second depth image.

According to an aspect of the disclosure, an electronic device may include a memory storing instructions, and a processor, where the instructions, when executed by the processor, may cause the electronic device to obtain a first image including an RGB image and a first depth image as components of the first image, obtain at least two image regions by processing the first image based on gaze point information through an AI network, and obtain a second depth image based on the at least two image regions, wherein, in the at least two image regions, image qualities of respective image regions may be different, and a resolution of the first depth image may be lower than a resolution of the second depth image.

The at least two image regions may include a first image region obtained based on an image feature of a first region in the first image centered on a gaze point, a second image region obtained based on an image feature of a second region in the first image centered on the gaze point, and a third image region obtained based on an image feature of the first image, and a pixel size of the second region may be greater than a pixel size of the first region.

The instructions, when executed by the processor, may cause the electronic device to obtain the at least two image regions by obtaining, through a first network, a first image region by processing a first region in the first image that is determined based on the gaze point information, and obtaining, through a second network, at least one other image region by processing a region in the first image other than the first region, and the second network comprises a partial network structure of the first network.

Th instructions, when executed by the processor, may cause the electronic device to obtain the at least two image regions by obtaining a shallow feature of the first image, obtaining at least one image region by performing feature reconstruction on the shallow feature, obtaining, based on the shallow feature, a deep feature of a first region in the first image that is determined based on the gaze point information, and obtaining a first image region by performing feature reconstruction on the deep feature.

The instructions, when executed by the processor, may cause the electronic device to obtain the at least two image regions by obtaining a first shallow feature of the first image, obtaining a third image region by performing feature reconstruction on the first shallow feature, obtaining, based on the first shallow feature, a second shallow feature of a second region in the first image that is determined based on the gaze point information, and obtaining a second image region by performing feature reconstruction on the second shallow feature, and a pixel size of the second region may be greater than a pixel size of the first region.

The instructions, when executed by the processor, may further cause the electronic device to obtain a virtual object and obtain a third image comprising the virtual object based on the RGB image and the second depth image.

A non-transitory, computer-readable storage medium may store instructions that, when executed by a processor, cause the processor to obtain a first image, where the first image includes an RGB image and a first depth image as components of the first image, obtain at least two image regions by processing the first image through an AI network based on gaze point information, and obtain a second depth image based on the at least two image regions, wherein, in the at least two image regions, image qualities of respective image regions are different and a resolution of the first depth image is lower than a resolution of the second depth image.

The at least two image regions may include a first image region obtained based on an image feature of a first region in the first image centered on a gaze point, a second image region obtained based on an image feature of a second region in the first image centered on the gaze point, where a pixel size of the second region may be greater than a pixel size of the first region, and a third image region obtained based on an image feature of the first image.

The instructions, when executed by the processor, may cause the processor to obtain the at least two image regions by obtaining a first image region by processing, through a first network, a first region in the first image that is determined based on the gaze point information, and obtaining at least one second image region by processing, through a second network, a region in the first image other than the first region, wherein the second network comprises a partial network structure of the first network.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a flowchart illustrating a method executed by an electronic device according to one or more embodiments of the disclosure;

FIG. 2A is a flowchart illustrating a foveated guided depth super resolution method according to one or more embodiments of the disclosure;

FIG. 2B is a diagram of processing based on gaze point information, according to one or more embodiments of the disclosure;

FIG. 3 is a diagram of a parallel-connected network architecture according to one or more embodiments of the disclosure;

FIG. 4A is a network architecture diagram of fast depth super resolution (FDSR), according to one or more embodiments of the disclosure;

FIG. 4B is a network architecture diagram of lightweight FDSR, according to one or more embodiments of the disclosure;

FIG. 5 is a diagram of a sequentially-connected network architecture according to one or more embodiments of the disclosure;

FIG. 6 is a diagram of an architecture of a sequential foveated guided depth super resolution network, according to one or more embodiments of the disclosure;

FIG. 7A is a diagram of multi-RGB feature aggregation for a second region, according to one or more embodiments of the disclosure;

FIG. 7B is a diagram of multi-depth feature aggregation for a second region, according to one or more embodiments of the disclosure;

FIG. 7C is a diagram of multi-RGB feature aggregation for a first region, according to one or more embodiments of the disclosure;

FIG. 7D is a diagram of multi-depth feature aggregation for a first region, according to one or more embodiments of the disclosure;

FIG. 8 is a network architecture diagram of multi-modal feature fusion (MMFF), according to one or more embodiments of the disclosure;

FIG. 9 is a network architecture diagram of cross-modal pixel attention (CMPA), according to one or more embodiments of the disclosure;

FIG. 10 is a network architecture diagram of multi-scale pixel attention (MSPA), according to one or more embodiments of the disclosure;

FIG. 11 is a diagram of effect comparisons according to one or more embodiments of the disclosure;

FIG. 12 is an application example diagram according to one or more embodiments of the disclosure; and

FIG. 13 is a diagram of a structure of an electronic device according to one or more embodiments of the disclosure.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

The following description with reference to the drawings is provided to facilitate a comprehensive understanding of various embodiments of the disclosure defined by the claims and their equivalents. The description includes numerous specific details to aid understanding but should be considered as examples only. Accordingly, those skilled in the art will recognize that various modifications and variations may be made to the various embodiments described herein without departing from the scope and spirit of the disclosure. In addition, for clarity and brevity, descriptions of the known functions and structures may be omitted.

Terms and expressions used in the following specification and claims are not to be limited to their dictionary meanings, but have been used by the inventors to enable a clear and consistent understanding of the disclosure. Accordingly, it will be apparent to those skilled in the art that the following description of various embodiments of the disclosure is provided for illustrative purposes only and is not intended to limit the disclosure as defined by the appended claims and their equivalents.

It should be understood that singular articles and antecedents also include plurals unless the context clearly indicates otherwise. Accordingly, for example, the reference ‘the surface of a component’ includes reference to one or more such surfaces. When it is expressed that one component is ‘connected’ or ‘coupled’ to another component, the one component may be directly connected or coupled to the other component, and it may also mean that the one component and the other component establish a connection relationship through an intermediate component. In addition, the term ‘connection’ or ‘coupling’ as used herein may include wireless connection or wireless coupling.

The term ‘include’ or ‘may include’ does not limit the presence of one or more additional features, operations, or characteristics, but rather the presence of correspondingly disclosed functions, operations or modules that can be used in various embodiments of the present disclosure. Also, the term ‘include’ or ‘have’ may be interpreted as referring to a particular characteristic, number, operation, component, module, or a combination thereof, but should not be interpreted as excluding the possibility of the presence of one or more other characteristics, numbers, operations, components, modules, or combinations thereof.

Unless otherwise defined, all terms (including technical or scientific terms) used in the disclosure have the same meaning as understood by one of ordinary skill in the art as described in the disclosure. Common terms defined in the dictionary are to be interpreted to have a meaning consistent with the context of the relevant technical field and should not be interpreted ideally or overly formally unless explicitly defined in the disclosure.

At least some functions of a device or electronic device according to one or more embodiments of the disclosure may be implemented through an artificial intelligence (AI) model, for example, at least one of a plurality of modules of the device or the electronic device may be implemented through the AI model. AI-related functions may be executed through non-volatile memory, volatile memory, and processors.

The processors may include one or more processors. The one or more processors may be general-purpose processors such as central processing units (CPU), application processors (AP), or the like, may be pure graphics processing units such as graphics processing units (GPU) and vision processing units (VPU), or may be AI-dedicated processors such as neural processing units (NPU).

The one or more processors control processing of input data according to predefined operating rules or AI models stored in non-volatile memory and volatile memory. The predefined operating rules or AI models are provided through training or learning.

Herein, providing through learning may refer to applying a learning algorithm to multiple pieces of learning data to obtain an AI model having the predefined operating rules or desired features. The learning described above may be executed on a device or electronic device itself on which AI according to one or more embodiments is executed, and/or may be implemented through a server/system.

An AI model may include a plurality of neural network layers. Each layer has a plurality of weights, and each layer performs neural network computations through computations between input data of the layer (computation results of a previous layer and/or input data of the AI model) and the plurality of weights of a current layer. Examples of neural networks include a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q-network (DQN), but is not limited thereto.

The learning algorithm is a method of training a specific target device (for example, a robot) by using a plurality pieces of learning data to allow or control the target device to determine or predict. Examples of the learning algorithm include supervised learning, unsupervised learning, semi-supervised learning, or reinforcement learning, but are not limited thereto.

A method provided in the disclosure may relate to one or more fields of technology, such as speech, language, image, video, or data intelligence.

In the case related to the field of speech or language, according to the disclosure, in a method executed by an electronic device, a method for augmented reality (AR) interaction may receive a speech signal as an analog signal through a collection module (for example, a microphone) of the electronic device, and may convert a speech portion into computer-readable text by using an automatic speech recognition (ASR) model. The utterance intention of a user may be obtained by interpreting the converted text by using a natural language understanding (NLU) model. The ASR model or NLU model may be an AI model. An AI model may be processed by an AI-specific processor designed with a hardware configuration specified for AI model processing. The AI model may be obtained through training. Here, ‘it may be obtained through training’ may refer to obtaining a predefined operating rule or AI model configured to execute a desired feature (or purpose) by training a basic AI model by using multiple pieces of training data through a training algorithm. Language understanding is a technology of recognizing and applying/processing human languages/text, which includes, for example, natural language processing, machine translation, conversational systems, question answering, or speech recognition/synthesis.

In the case related to the field of image or video, according to the disclosure, in a method executed by an electronic device, a method for foveated guided depth super resolution may obtain output data in which an image or depth feature of the image is recognized by using image data as input data of an AI model. The AI model may be obtained through training. Here, ‘it may be obtained through training’ may refer to obtaining a predefined operating rule or AI model configured to execute a desired feature (or purpose) by training a basic AI model by using multiple pieces of training data through a training algorithm. A method of the disclosure may be related to the field of visual understanding of AI technology. Visual understanding is a technology for recognizing things like human vision and processing objects, which includes, for example, object recognition, object tracking, image retrieval, human recognition, scene recognition, three-dimensional (3D) reconstruction/positioning, or image augmentation.

In the case related to the field of data intelligence processing, according to the disclosure, in a method executed by an electronic device, a method of inferring or predicting a depth image may be executed by using an AI model. A processor of the electronic device may execute pre-processing operations on data to transform the data into a format suitable for use as an input to an AI model. The AI model may be obtained through training. Here, ‘it may be obtained through training’ may refer to obtaining a predefined operating rule or AI model configured to execute a desired feature (or purpose) by training a basic AI model by using multiple pieces of training data through a training algorithm. Inferring and predicting are techniques for logically inferring and predicting by determining information, which includes, for example, inference based on knowledge (for example, contextual information), optimized prediction, and preference-based planning or recommendation.

AR is a technology that merges virtual information (for example, text, images, music, videos, or the like) with the real world. In an implementation process, real-world data may be captured through a camera or sensor, and then virtual information and the real-world data may be mixed and superimposed to generate a new virtual image, the virtual image may be provided to a user through a display device (for example, AR glasses, a mobile phone, or the like), and the user may interact (AR interaction) with the virtual information through an intelligence interaction (for example, speech recognition and gesture recognition) method.

Depth image accuracy is particularly important in AR interactions. In related technologies, a prediction method for depth images predicts an entire image, which has low processing efficiency and is difficult to apply to AR scenes at real-time speed.

One or more embodiments of the disclosure may provide a gaze-based foveated depth image super resolution method, which may predict a depth image by using a method of obtaining different levels of image quality for different regions of an image according to gaze point information, and the method may reduce computational complexity and processing delay and improve image processing efficiency while maintaining the accuracy of a user focus region.

Hereinafter, the technical solutions embodiments of the disclosure and the technical effects of the technical solutions of the disclosure are explained through descriptions of several embodiments. The following implementation embodiments may be referenced, borrowed, or combined with each other, and the same terms, similar features, and similar implementation operations are not repeatedly described.

Hereinafter, an image processing method according to one or more embodiments of the disclosure is described.

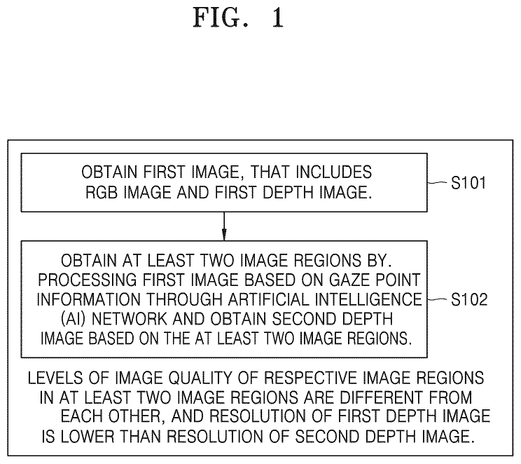

FIG. 1 is a flowchart illustrating a method executed by an electronic device according to one or more embodiments of the disclosure.

As shown in FIG. 1, the method according to one or more embodiments of the disclosure includes operations S101 to S102.

In operation S101, a first image may be obtained, the first image including an RGB image and a first depth image. That is, the first image may include an RGB image component and a first depth image component. The RGB image and the first depth image may be components of the first image, and thus the first image may be referred to as including the RGB image and the first depth image.

In operation S102, the first image may be processed based on gaze point information through an AI network to obtain at least two image regions, and obtaining a second depth image based on the at least two image regions.

In the at least two image regions, the levels of image quality of respective image regions are different from each other, and the resolution of the first depth image is lower than the resolution of the second depth image.

The RGB image is an image composed of three primary colors of red, green, and blue, and represents image content based on a color channel. A depth image, which is also known as a distance effect or a depth map, may refer to an image using distances (depth) from an image collector to respective points in a scene as pixel values, and may reflect geometric shape of visible surfaces in the scene. The RGB image and the depth image may be aligned to have one-to-one correspondence between pixels, and accordingly, depth information and color information may be combined to each other to provide a more comprehensive scene description.

The gaze point information may be determined by tracking a user's eye movements via sensors or cameras, and may include the user's gaze point position (also referred to as gaze position, such as a focus of the user's gaze point within an AR scene), gaze duration of time (for example, a length of time the user gazes at a point continuously), gaze path (for example, the trajectory of the user's gaze movement within the scene), or the like. In addition to directly determining the user's eye movement and head posture, the gaze point may also be indirectly determined by analyzing the user's interaction behavior, and for example, the user's interaction behaviors such as hand gestures and voice inputs within the AR scene may be reference data for inferring the gaze point.

The image quality may refer to an extent to which the electronic device may extract relevant feature information from an image, and is focused on whether the image clearly conveys intention and content that the electronic device may understand and recognize. In the field of image processing, high-quality images may describe more comprehensive information, but may have a greater corresponding amount of computation and higher processing complexity. On the contrary, low-quality images may lose or blur some details and textures, but may have a less corresponding amount of computation and lower processing complexity.

An RGB image input to an AI network may be high-resolution image (HR RGB), a first depth image may be a low-resolution image (LR Depth), and a second depth image processed and output by the AI network may be a high-resolution image (HR Depth). That is, the AI network according to one or more embodiments of the disclosure may restore a depth image. In one or more embodiments of the disclosure, the input image may also be an image having different resolutions.

In one or more embodiments of the disclosure, when processing a first image through an AI network, the RGB image and the first depth image may be respectively processed first, and during the processing, the RGB image and the first depth image may be fused together. When processing an image based on gaze point information, the image may be segmented, different image regions with different levels of image quality may be obtained by performing different processing on different regions, and the second depth image may be output based on the obtained image regions. Because the respective levels of image quality of the at least two image regions obtained based on gaze point information are different from each other, a process of obtaining a high-resolution second depth image based on the at least two image regions may reduce an amount of computation and complexity of image processing and improve the efficiency of image processing, thereby meeting the real-time requirement of image processing. One or more embodiments of the disclosure may improve the speed of image processing, reduce processing delay, and implement real-time processing of images by performing image processing by using a method with less amount of computation and lower processing complexity for partial regions within an image, while maintaining image accuracy of a region related to a gaze point.

In one or more embodiments, an image region obtained by processing the first image may include three image regions.

A first image region is obtained based on an image feature of a first region centered on a gaze point in a first image.

A second image region is obtained based on an image feature of a second region centered on a gaze point in the first image. A pixel size of the second region is greater than a pixel size of the first region.

A third image region is obtained based on an image feature of the first image.

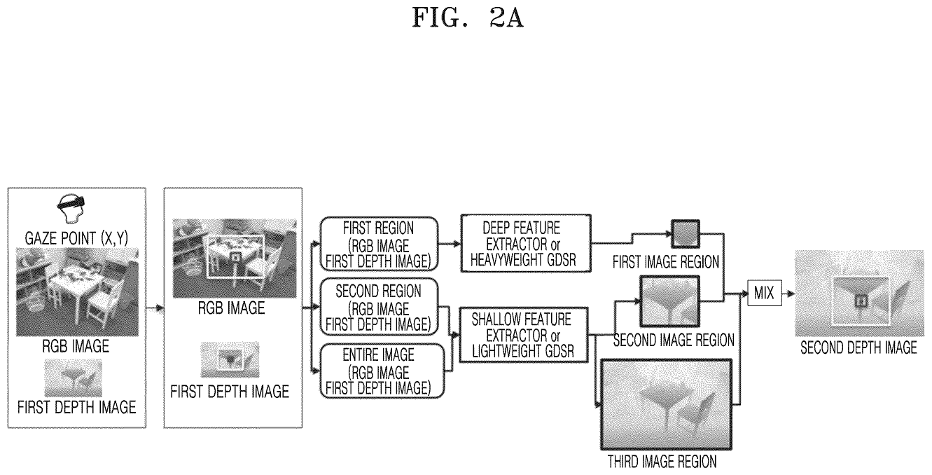

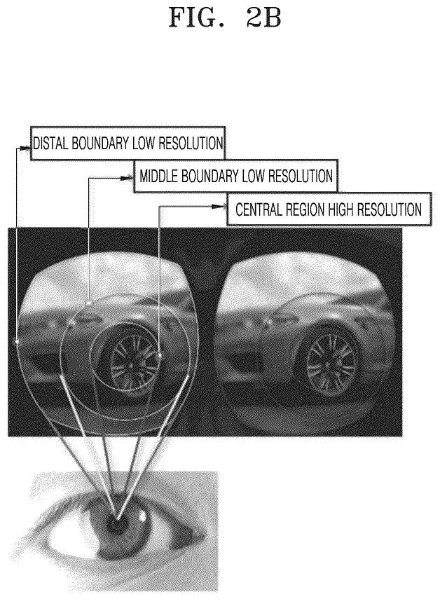

FIG. 2A is a flowchart illustrating a foveated guided depth super resolution method according to one or more embodiments of the disclosure.

As shown in FIG. 2A, when processing the first image based on gaze point information, a plurality of regions may be obtained by dynamically segmenting the first image according to the gaze point information, and a depth image super resolution method with different depth features or different complexities for different regions may be used to perform depth image super resolution processing. When performing image segmentation, in addition to determining a first region (also referred to as a foveated region of human eyes or orbital region) based on the gaze point information, a second region (also referred to as a middle boundary region or a middle peripheral region) having a greater pixel size than the pixel size of the first region may also be determined based on the gaze point information, so that features of the first region and the second region may be aggregated in subsequent processing, and the loss of depth quality of the image may be reduced. For example, a size of the first region may be set to 256*256, and a size of the second region may be set to 400*400.

Because a gaze point is not necessarily positioned at the center of the first image, when the image is segmented around the gaze point, the gaze point within the first and second regions obtained by segmentation is not necessarily positioned at the center of the corresponding region. For example, when the first region having a radius of 128 pixels is obtained around the gaze point, the position of the gaze point within the image may be biased to the left side, and thus a situation may occur in which the segmented first region is a non-circular region (for example, some regions on the left side are omitted). When the second region having a radius of 200 pixels is obtained around the gaze point, the position of the gaze point within the image may be biased to the left side, and thus a situation may occur in which the segmented second region is a non-circular region (for example, some regions on the left side are omitted). Correspondingly, the size of a region occupied by the first region within the first image may be smaller than the size (for example, the pixel size) of a region occupied by the second region within the first image.

During image processing, the first image may be regarded as a third region (also referred to as a distal peripheral region or a distal boundary region) segmented based on the gaze point information, that is, a third image region obtained by processing the entire image of the first image.

The first image may be segmented based on the gaze point information while ensuring the accuracy of a final output image, image pixels included between respective obtained regions may not overlap each other, and a processed image content may be reduced to improve the speed and efficiency of image processing. The second region does not include image pixels included in the first region, and the third region does not include image pixels included in the first region and the second region. Correspondingly, the second image region does not include the image content of the first image region, and the third image region does not include the image contents of the first image region and the second image region.

FIG. 2B is a diagram of processing based on gaze point information, according to one or more embodiments of the disclosure.

For example, as shown in FIG. 2B, the resolution of different regions within an image may be different from each other to suit the vision of human eyes, the details in an orbital region may be clearer, and the details in an image boundary region may be less or more ambiguous. One or more embodiments of the disclosure may be suitable for the above situation, and may segment an image into regions with slightly different pixel sizes based on gaze point information.

As shown in FIG. 2A, the first image region (foveal, orbital image) may be obtained based on the first region corresponding to each of an RGB image and a first depth image. The second image region (middle periphery) may be obtained based on the second region corresponding to each of an RGB image and a first depth image. The third image region (far periphery) may be obtained based on an RGB image and a first depth image.

For example, as shown in FIG. 2A, each of the RGB image and the first depth image may be segmented to obtain the first region, the second region, and the entire region (for example, the third region) corresponding to each of the RGB image and the first depth image based on gaze point information, and then the first region, the second region, and the entire region may be processed through an AI model of features of various depths and/or various complexities to obtain image regions of various levels of image quality.

While meeting the real-time requirements of image processing, the second region obtained by segmentation based on the gaze point information may include a plurality of second regions, the image sizes of the plurality of second regions obtained by segmentation may be different from each other, and the processing of the plurality of second regions may effectively reduce the loss of depth quality caused by image cropping. For example, the RGB image and the first depth image may include a first region, a second region, and a third region (for example, an entire image), and the image sizes of respective regions are sorted from smallest to largest.

An image feature of each region may include an RGB feature within the RGB image and a depth feature within the first depth image.

For example, in terms of the image quality of the image content included in the first region, the image quality of the first image region is higher than that of other regions.

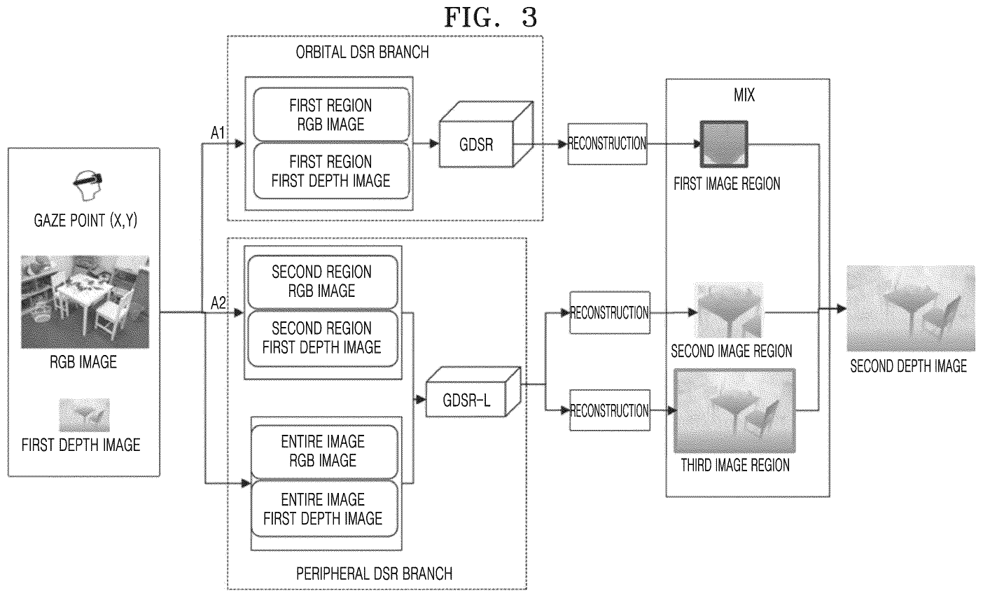

FIG. 3 is a diagram of a parallel-connected network architecture according to one or more embodiments of the disclosure.

In one or more embodiments, a parallel foveated guided depth super resolution (FoV-GDSR) network architecture may be provided, as shown in FIG. 3, in the network architecture, a heavyweight GDSR model may be used for a first region, and a lightweight DSR model or lightweight GDSR model (for example, GFSR-L) may be used for other regions to predict other regions of the first depth image.

In operation S102, the first image is processed based on the gaze point information through the AI network to obtain at least two image regions, which may include operation A1 and operation A2.

In operation A1, the first image region may be obtained by processing the first region determined based on the gaze point information within the first image through a first network.

In operation A2, at least one other image region may be obtained by processing a region other than the first region within the first image through a second network.

As shown in FIG. 3, an AI network used in one or more embodiments of the disclosure may include two parallel branches implemented by the first network and the second network, an orbital DSR branch and a peripheral DSR branch. In the first region determined based on the gaze point information, image processing may be performed by using the GDSR, and an output result may be reconstructed to obtain the first image region in which RGB information and depth information are mixed. In the other region determined based on the gaze point information, image processing may be performed by using a more lightweight model compared to the GDSR, and an output result may be reconstructed to obtain other image regions in which RGB information and depth information are mixed.

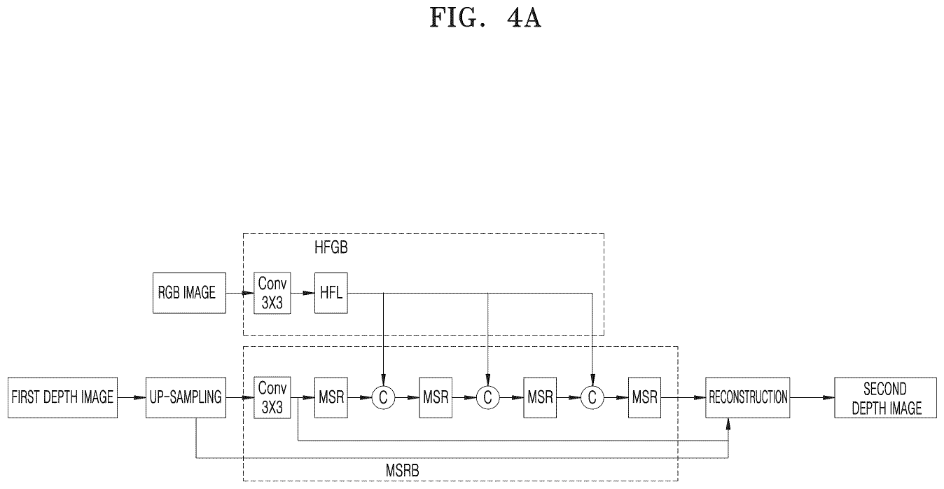

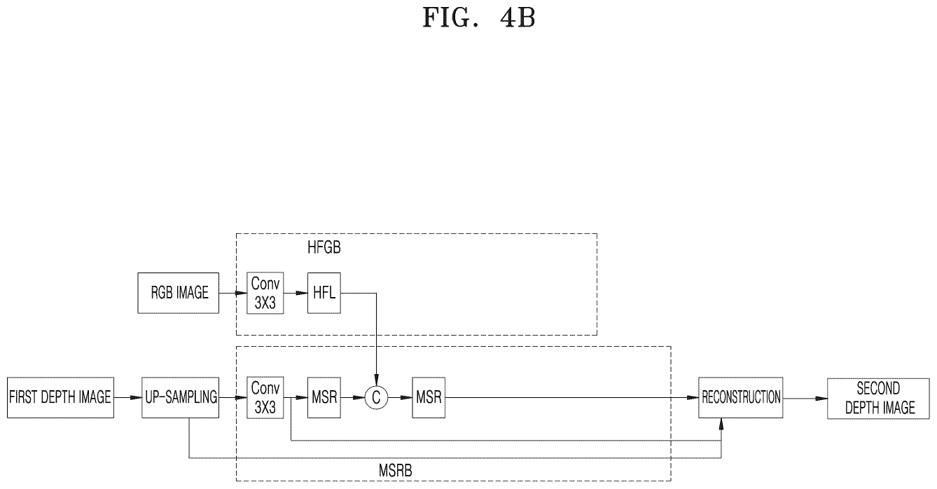

FIG. 4A is a network architecture diagram of fast depth super resolution (FDSR), according to one or more embodiments of the disclosure. FIG. 4B is a network architecture diagram of lightweight FDSR, according to one or more embodiments of the disclosure.

For example, a FDSR model (as shown in FIG. 4A) may be used for the first region, and a lightweight FDSR model (as shown in FIG. 4B) may be used to perform image processing for other regions.

In the FDSR model, the RGB image may be processed by using a high frequency guidance branch (HFGB), the branch may include multiple high frequency layers (HFL) that are sequentially connected, and may improve the accuracy of image processing by processing appropriately for a situation where images change rapidly in an AR scene. In the first depth image, when an input is a first depth image with low resolution, the first depth image may be first up-sampled and then processed through a multi-scale reconstruction branch (MSRB), the branch may include multiple multi-scale reconstruction (MSR) modules that are sequentially connected, a connection relationship may be included between the HFL and the MSR module at each level, and as a final output feature may be reconstructed to obtain an image region of a corresponding region, respective image regions may be merged, and a second depth image output by the AI network as a whole may be obtained.

As may be seen by comparing the FDSR model shown in FIG. 4A with the lightweight FDSR model shown in FIG. 4B, the lightweight FDSR model may have fewer level structures, fewer model parameters, lower complexity of image processing, and less amount of operation to be executed, and thus the lightweight FDSR model may effectively improve the efficiency of image processing. When processing using a heavyweight AI model for the first region, the image accuracy of an output first image region may be secured, and at the same time, the requirements for image accuracy required for various regions of the depth image in an AR scene may also be secured.

The second network may include a partial network structure of the first network. For example, as shown in FIGS. 4A and 4B, the first network may use a network structure shown in FIG. 4A, and the second network may use a network structure shown in FIG. 4B. In comparison, the number of MSR modules included in the first network in an MSRB circuit is greater than the number of MSR modules included in the second network. The first network may include more HFL modules, such as two, three, or the like, than those shown in FIG. 4A. Correspondingly, the number of HFL modules included in the second network may be less than the number of HFL modules included in the first network.

In one or more embodiments, when considering that the accuracy requirements for images other than the first region are low, a method of using a concise network structure may reduce the computational complexity of the second network and improve the processing speed of the second network, thereby improving the overall processing speed of the AI network and improving the efficiency of image processing.

An example is described below with reference to experimental data.

As shown in Table 1, although parameters of parallel-FoV-FDSR slightly increased compared to FDSR, the inference speed of the entire model was greatly improved. In particular, at high resolution (AVP: 3840×3000), floating point operations per second (FLOPs) (also referred to as an amount of computation, which may measure the complexity of an algorithm model) was reduced by 5 times, and the speed was improved by more than 2 times. Quest 3 and Apple Vision Pro (AVP) are virtual reality head display products. The numbers represent resolution characteristics.

TABLE 1
Comparison of model parameters, FLOPs, and inference time:

| METHOD | | FDSR | Parallel-FoV-FDSR |
|---|---|---|---|
| PARAMETERS (K) | | 601.11 | 861.42 |
| FLOPs(G) ↓ | 1280*960 | 57.52 | 14.06 |
| | 2064*2208(Quest3) | 205.93 | 40.81 |
| | 3840*3000(AVP) | 514.78 | 96.76 |
| SPEED (ms) ↓ | 1280*960 | 36.5 | 26.5 |
| GPU-V100 | 2064*2208(Quest3) | 108.1 | 45.5 |
| | 3840*3000(AVP) | 209.3 | 81.7 |

Experimental measurements show that the depth quality of the foveated region (for example, the first region) is slightly lower than that of the entire image. This may be because the foveated region contains only partial information, so the foveated network branch may not use the contextual feature information of the entire image, resulting in reduced performance. As shown in Table 2 below.

TABLE 2
Performance of Parallel-FoV-FDSR
and FDSR on different datasets:

| | DATASET 1 FIRST | | DATASET 2 FIRST | |
|---|---|---|---|---|
| | CENTER REGION/ | | CENTER REGION/ | |
| | ENTIRE IMAGE | | ENTIRE IMAGE | |
| | RMSE(cm) | DEPTH | RMSE(cm) | DEPTH |
| METHOD | ↓ | ERROR (%) | ↓ | ERROR (%) |
| FDSR | 2.04/1.62 | 0.23/0.18 | 1.15/0.83 | 0.55/0.35 |
| Parallel- | 2.26/1.88 | 0.25/0.21 | 1.22/0.93 | 0.58/0.37 |
| FoV-FDSR | | | | |

A root mean square error (RMSE) may measure the accuracy of a depth image. The smaller the value of the RMSE, the smaller the difference between a predicted depth value and an actual depth value, that is, the higher the accuracy of the depth image. Dataset 1 may be an NYUv2 dataset (also referred to as an NYU-Depth V2 dataset, for example, a computer vision dataset). Dataset 2 may be a Lu dataset derived from deep augmentation via a completion network of low-rank matrices.

Referring to the experimental data in Table 1 and Table 2, the parallel-FoV-FDSR according to one or more embodiments of the disclosure may obtain the accuracy of a depth image similar to that of FDSR, and the processing speed is also greatly improved. That is, the implementation of the disclosure may realize the improvement of image processing efficiency and the reduction of processing delay under a premise of maintaining the accuracy of an output image.

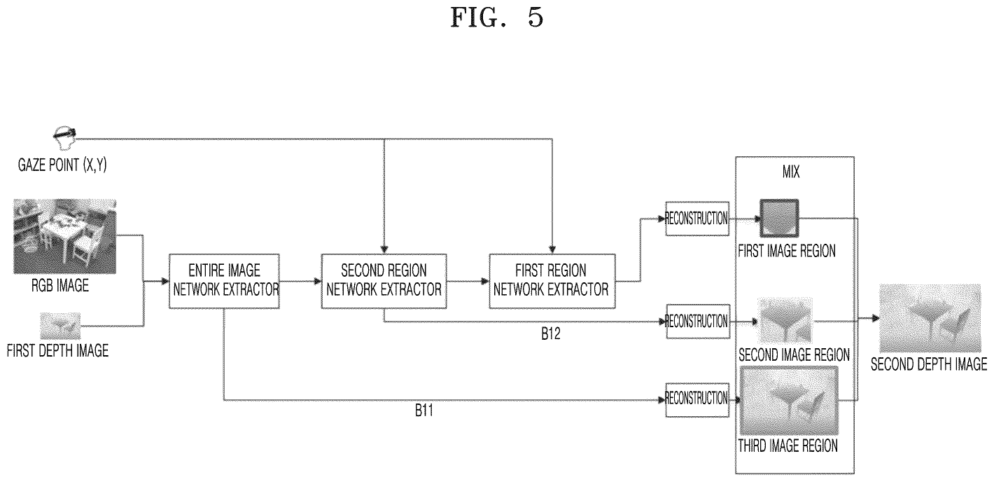

FIG. 5 is a diagram of a sequentially-connected network architecture according to one or more embodiments of the disclosure.

In one or more embodiments, a sequential-FoV-GDSR network architecture is provided. For example, as shown in FIG. 5, the network may become deeper gradually, a shallow network may extract features of an entire image and a second region to make predictions, and a deep network may extract features of a foveated region (for example, a first region) to make predictions, thereby obtaining more accurate prediction results.

In S102, the first image may be processed based on gaze point information to obtain at least two image regions, which may include operation B1 and operation B2.

In operation B1, a shallow feature of the first image may be obtained, and at least one image region may be obtained by performing feature reconstruction for the shallow feature.

In operation B2, based on the shallow feature, a depth feature of a first region determined based on the gaze point information within the first image may be obtained, and a first image region may be obtained by performing feature reconstruction for the depth feature.

The shallow feature may include some details within the image, such as boundaries, edges, colors, pixels, gradients, or the like. The depth feature may be formed on the shallow feature and have rich semantic information.

In one or more embodiments of the disclosure, the shallow feature may be obtained and processed for regions having low image accuracy requirements, the depth feature may be obtained and processed for regions having high image accuracy requirements, and image processing may be performed by using features of different depths for other regions, so that the accuracy of the image may be maintained while reducing computational complexity and improving processing efficiency.

In operation B1, the shallow feature of the first image may be obtained, at least one image region may be obtained by performing feature reconstruction for the shallow feature, and may include operation B11 and operation B12.

In operation B11, a first shallow feature of the first image may be obtained, and a third image region may be obtained by performing feature reconstruction for the first shallow feature.

As shown in FIG. 5, the first shallow feature of the first image may be obtained by using an entire image network extractor, and the third image region may be obtained by performing feature reconstruction processing through an independent reconstruction layer.

In operation B12, based on the first shallow feature, a second shallow feature of a second region determined based on the gaze point information within the first image is obtained, and a second image region is obtained by performing feature reconstruction for the second shallow feature.

Among these, the pixel size of the second region is greater than the pixel size of the first region.

As shown in FIG. 5, the first shallow feature output by the entire image network extractor may be an input of a second region network extractor, and at the same time, the second region within the first image may be determined based on the gaze point information, then the second shallow feature of the second region may be obtained based on the first shallow feature, and the second image region may be obtained by performing feature reconstruction processing through an independent reconstruction layer.

For example, as shown in FIG. 5, network extractors extracting features for different regions may be sequentially connected to each other, a feature obtained by extracting from the entire image through a shallow network may become an input for the next network extractor, and then a feature may be extracted for the second region determined based on the gaze point information through the shallow network, and the features obtained by extraction may become inputs for the next network extractors, and finally features for the first region determined based on the gaze point information may be extracted through the deep network. Then, the features obtained for other regions may be respectively reconstructed to obtain image regions corresponding to corresponding regions.

In one or more embodiments, a sequentially-connected network architecture using GDSR may be provided, and may include two branches including HFGB and multi-modal feature fusion (MMFF).

An LR depth map D_{LR}∈R^{H×W×1}, a corresponding HR RGB image G_{HR}∈R^{αH×αW×C}, and a gaze position P (x,y) are given. Implementation of the embodiment includes restoring a HR depth map D_{HR}∈R^{αH×αW} according to the guide of G_{HR}∈R^{αH×αW}. α is a dimensionality increasing factor, and H, W, and C represent height, width, and number of channels, respectively. D_{LR} may be amplified into HR space to obtain D_{U}∈R^{αH×αW} by using bicubic interpolation. In addition, D_{U} and G_{HR} forming a pair and the gaze position (x,y) may be input into nonlinear mapping of G_{HR}, and for example, Equation (1) may be used.

$${D}_{HR\_foveal} = {D}_{U\_foveal} + ℱ ( {D}_{{U}_{foveal}} , ℋ ( {G}_{HR\_foveal} ) , θ ) \qquad ( 1 )$$

$${D}_{HR\_mid \_periph} = {D}_{U\_mid \_periph} + ℱ ( {D}_{U\_mid \_periph} , ℋ ( {G}_{HR\_mid \_periph} ) , θ )$$

$${D}_{HR\_far \_periph} = {D}_{U\_far \_periph} + ℱ ( {D}_{U\_far \_periph} , ℋ ( {G}_{HR\_far \_periph} ) , θ )$$

$${D}_{HR} = ℬ ( {D}_{HR\_foveal} , {D}_{HR\_mid \_periph} , {D}_{HR\_far \_periph} )$$

Among these, [symbol] (·) is a function that trains the residual mapping between D_{U} and D_{HR}, G_{HR} is embedded in the high frequency extractor [symbol] (·) to provide high frequency guidance for depth map super resolution (SR), θ is a set of trained weights, and [symbol] (·) is a mixture. foveal corresponds to the first region, mid_periph corresponds to the second region, and far_periph corresponds to the entire image.

To prevent loss of contextual information when cropping an image, a feature aggregation module applicable to the first and second regions may also be provided, and the module may be multi-level feature aggregation (MLFA). The MLFA may reorganize some features extracted from a previous level, serially connect these features and then perform convolution processing to generate more representative features, that is, to obtain better feature representations. For example, the convolution processing of the MLFA may be implemented through 3×3 and 1×1 convolution layers, and it may be understood that the overhead of the convolution layers is very small compared to the entire AI network, and thus the overhead of the convolution layers may be ignored. That is, the MLFA according to one or more embodiments of the disclosure may obtain better feature representations without affecting image processing efficiency, and thus it may be beneficial to maintaining the accuracy of depth images output by AI networks.

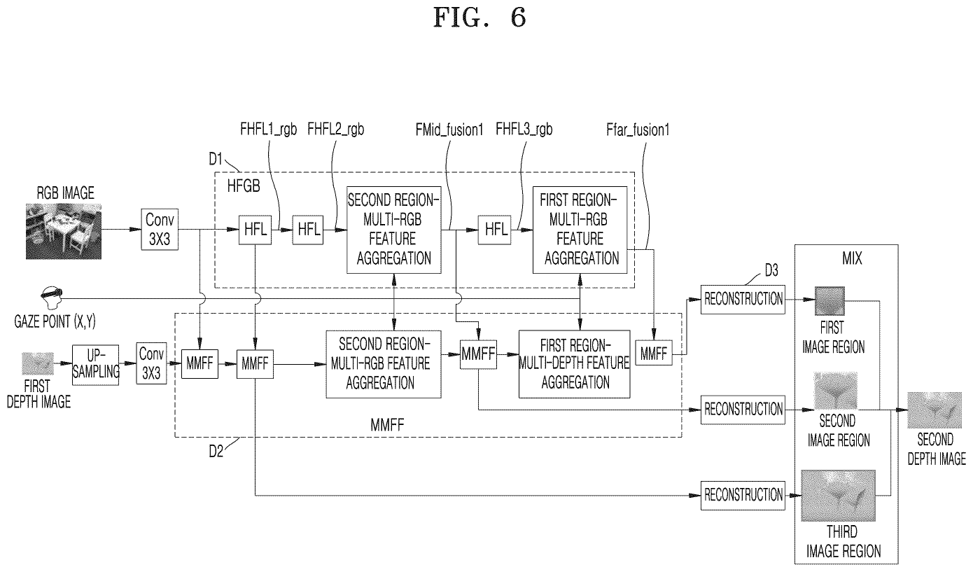

FIG. 6 is a diagram of an architecture of a sequential foveated guided depth super resolution network, according to one or more embodiments of the disclosure.

The previous level may refer to all network layers arranged before the current network layer in the network structure. For example, as shown in FIG. 6, a previous level of a second HFL layer in the HFGB includes a 3*3 convolutional layer and a first HFL layer.

The AI network may include a third network and a fourth network, and there may be a connection relationship between network layers of the third network and the fourth network.

As in the HFGB shown in FIG. 6, the third network may include at least one first network layer (for example, a HFL or another AI network layer for extracting high frequency features) and at least one second network layer (for example, an MLFA or another AI network layer for aggregating features). The first network layer may obtain high frequency features within an RGB image. The second network layer may be connected to the first network layer and aggregate features output by the previous levels. For example, when two first network layers are serially chained before the second network layer, the second network layer may aggregate output features of the two first network layers.

As in the MMFF branch shown in FIG. 6, a fourth network may include at least one third network layer (for example, an MMFF or another AI module for fusion of features) and at least one fourth network layer (for example, an MLFA or another AI network layer for aggregating features). The third network layer may fuse the depth feature of the first depth image and the high frequency feature output by the third network. The fourth network layer may be connected to the third network layer and aggregate features output by the previous levels.

For example, the third network may include multiple HFLs and multiple MLFAs, and the fourth network may include multiple MMFFs and multiple MLFAs. An output of a first HFL may be an input of second MMFF. An output of first MLFA of the third network may be an input of third MMFF. An output of second MLFA of the third network may be an input of fourth MMFF.

In a connection relationship between the third network and the fourth network, a connection between a second HFL and first MLFA of the fourth network and a connection between a third HFL and the third MMFF and/or second MLFA of the fourth network may be further included, and the network connection between other network branches may be implemented with effective feature extraction, which may restore the first depth image through the RGB image and improve the accuracy of an output image.

In S102, the first image may be processed based on the gaze point information to obtain at least two image regions, which may include operation D1 to operation D3.

In operation D1, based on the RGB image through the third network, high frequency features of at least two regions determined based on the gaze point information are obtained. The high frequency features include features that represent detail information and/or edge information.

As shown in FIG. 6, a high frequency feature FHFL1_rgb of an entire RGB image is obtained through the first HFL. Then, the high frequency feature FHFL1_rgb may be an input of the second HFL, and obtains a high frequency feature FHFL2_rgb (for example, performing additional processing such as augmentation on the extracted feature). Then, features obtained at respective level are aggregated through the first MLFA, the second region is processed based on the feature obtained by aggregation, and a high frequency feature FMid_fusion1 corresponding to the second region is obtained. Then, a high frequency feature FHFL3_rgb is obtained through the third HFL, features obtained at respective previous levels are aggregated through the second MLFA, the first region is processed based on the feature obtained by aggregation, and a high frequency Ffar_fusion1 corresponding to the first region is obtained.

As shown in FIG. 6, the third network may further include a convolution layer (Conv 3×3) that performs convolution processing on an input RGB image, and may extract and map features Fconv_rgb from the RGB image, which may serve as the basis for subsequent feature training and processing to be beneficial to improving the performance and efficiency of the AI network.

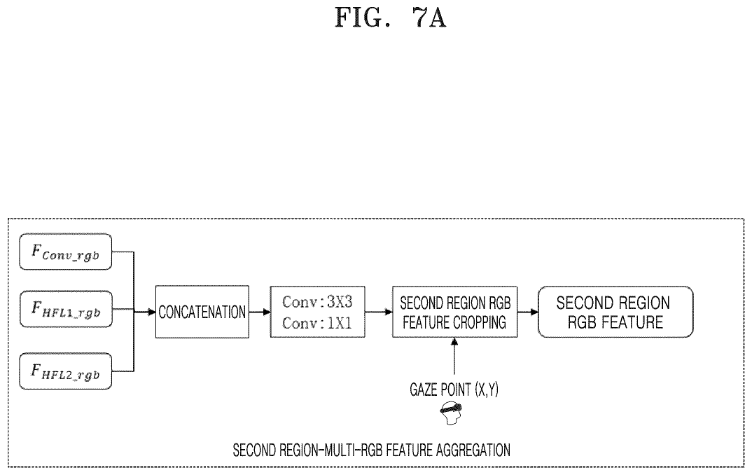

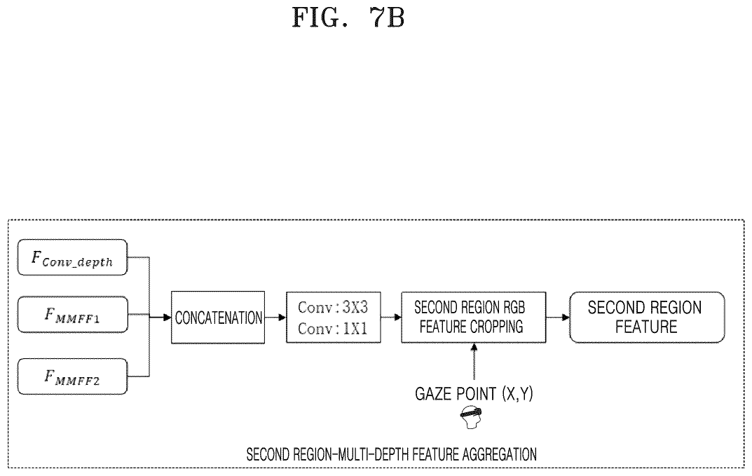

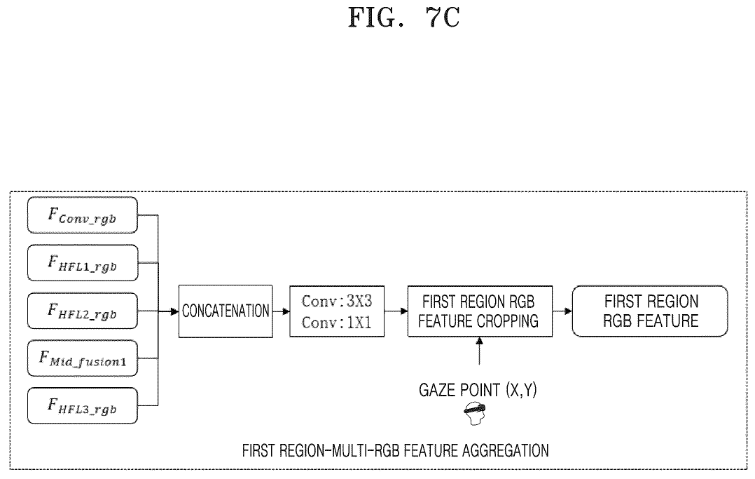

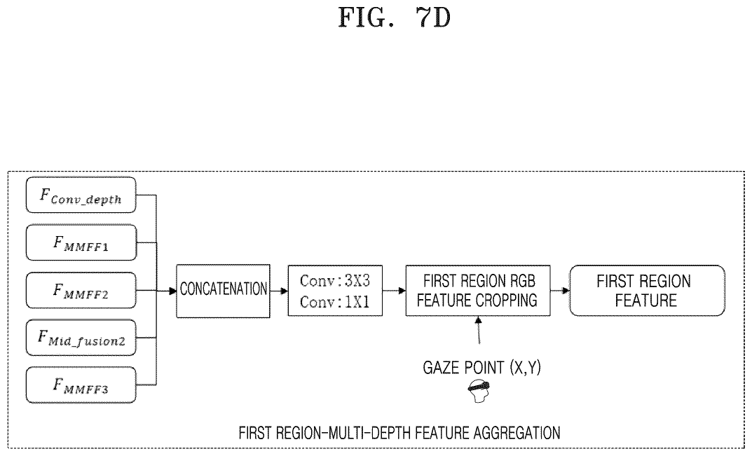

FIG. 7A is a diagram of multi-RGB feature aggregation for a second region, according to one or more embodiments of the disclosure. FIG. 7B is a diagram of multi-depth feature aggregation for a second region, according to one or more embodiments of the disclosure. FIG. 7C is a diagram of multi-RGB feature aggregation for a first region, according to one or more embodiments of the disclosure. FIG. 7D is a diagram of multi-depth feature aggregation for a first region, according to one or more embodiments of the disclosure.

As shown in FIG. 7A, when processing the second region of the RGB image through the first MLFA, an input of the MLFA may include an output Fconv_rgb of a convolutional layer serially connected to the previous position, the output FHFL1_rgb of the first HFL, and the output FHFL2_rgb of the second HFL. These features may be processed through a concatenation layer (Concat), the feature obtained by processing may be input to the convolution layer (Conv: 3×3 Conv: 1×1) to be processed, and a better feature representation may be obtained. Then, the high frequency feature (middle periphery RGB feature) FMid_fusion1 of the second region determined from the RGB image based on the gaze point information may be obtained from the features output by the convolution layer.

As shown in FIG. 7C, when processing the first region of the RGB image through the second MLFA, an input of the MFLA may include the output Fconv_rgb of the convolution layer serially connected to the previous position, the output FHFL1_rgb of the first HFL, the output FHFL2_rgb of the second HFL, the output FMid_fusion1 of the first MLFA, and the output FHFL3_rgb of the third HFL. These features may be processed through a concatenation layer (Concat), the feature obtained by processing may be input to the convolution layer (Conv: 3×3 Conv: 1×1) to be processed, and a better feature representation may be obtained. Then, a high frequency feature (foveal feature) Ffar_fusion1 of the first region determined from the RGB image based on the gaze point information may be obtained from the features output by the convolution layer.

The 3×3 convolution of the convolution layer within the MLFA may better capture feature information from the input feature and improve the accuracy of the model. The 1×1 convolution may obtain more comprehensive information by aggregating various resolutions and semantic information of feature maps of various layers.

In operation D2, a first fusion feature corresponding to each of at least two region may be obtained based on depth features of the at least two regions determined based on the high frequency features and the gaze point information in the first depth image.

As shown in FIG. 6, in the fourth network, an RGB feature Fconv_rgb of the RGB image and a depth feature Fconv_depth of the first depth image may be fused through the first MMFF to obtain FMMFF1. Then, the high frequency feature FHFL1_rgb output by the first HFL and the fusion feature FMMFF1 output by the first MMFF may be fused to obtain FMMFF2 (for example, a first fusion feature of the entire image). Then, the features Fconv_depth, FMMFF1, and FMMFF2 output by the previous levels may be aggregated through the first MLFA, as shown in FIG. 7B, a feature FMid_fusion2 of the second region may be obtained, and then the high frequency feature FMid_fusion1 output by the first MLFA within the third network and a feature FMid_fusion2 output by the first MLFA within the fourth network may be fused through the third MMFF to obtain FMMFF3 (for example, the first fusion feature of the second region). Then, the output features Fconv_depth, FMMFF1, FMMFF2, FMid_fusion2, and FMMFF3 of the previous levels may be aggregated through the second MLFA within the fourth network, as shown in FIG. 7D, a feature Ffar_fusion2 of the first region may be obtained. Next, the high frequency Ffar_fusion1 output by the second MLFA within the third network and the feature Ffar_fusion2 output by the second MLFA within the fourth network may be fused through the fourth MMFF within the fourth network to obtain FMMFF4 (the first fusion feature of the first region).

As shown in FIG. 6, the fourth network may further include a convolution layer (Conv 3×3) that performs convolution processing on an input first depth image, and may extract and map the feature Fconv_depth from the first depth image, which may serve as the basis for subsequent feature training and processing to be beneficial to improving the performance and efficiency of the AI network.

As shown in FIGS. 7A to 7D, in the third network and the fourth network, the MLFAs that aggregate the features output by respective previous levels may use the same network structure, and the difference thereof is that inputs of respective MLFAs are different.

When a given first depth image is a low-resolution image, an RGB image may be a high-resolution image, and the clarity of the image may be improved by up-sampling the first depth image, thereby expressing richer detail information, which may serve as the basis for outputting high-resolution depth images in the future, improving the accuracy of the dept images output by the AI network.

In operation D3, at least two image regions may be obtained by performing feature reconstruction for the first fusion feature corresponding to each of the at least two regions.

As shown in FIG. 6, for the first fusion features FMMFF2, FMMFF3, and FMMFF4 of respective regions, feature reconstruction may be performed through a reconstruction layer (Recon.) to obtain image regions (for example, the third image region, the second image region, and the first image region) corresponding to respective regions.

In one or more embodiments, a provided MMFF module may reduce depth error by cross-modal and multi-scale fusion of the RGB feature and the depth feature. The processing of cross-modal may involve processing of various modal features, such as two-dimension, three-dimension, and colors. The processing of multi-scale may include processing of features, such as various sizes, shapes or structures of objects within an image, changes in scale due to perspectives of object positions, and occlusion, and/or may include processing of various scale features obtained from dilated convolutions.

In operation D2, the first fusion feature corresponding to each of at least two regions may be obtained based on the depth features of the at least two regions determined based on the high frequency features and the gaze point information within the first depth image, which may include operations in operation D21 to operation D23 to be executed for each region.

In operation D21, a second fusion feature may be obtained by performing feature fusion based on the high frequency feature output by the third network of the previous level and the depth feature output by the fourth network of the previous level.

In operation D22, a third fusion feature may be obtained by performing feature fusion of multi-scale based on the second fusion feature.

In operation D23, a first fusion feature may be obtained based on the high frequency feature output by the third network of the previous level, the depth feature output by the fourth network of the previous level, and the third fusion feature.

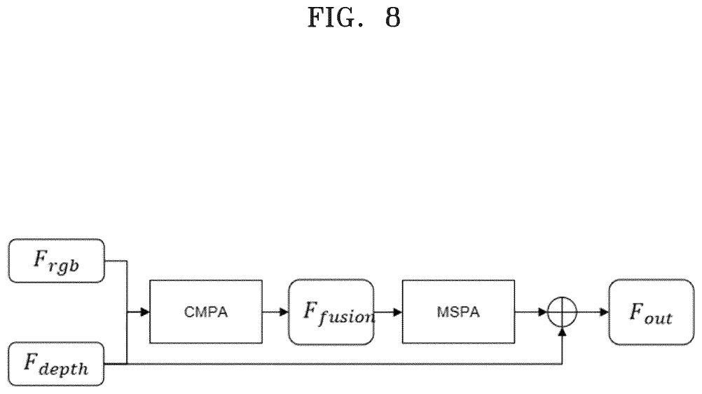

FIG. 8 is a network architecture diagram of MMFF, according to one or more embodiments of the disclosure.

As shown in FIG. 8, with respect to an RGB feature F_RGB of a given HFGB and a depth feature output by the previous layer, the texture regions that are not related to the object surface may be refined and the natural object boundaries in the depth domain may be enhanced to obtain the second fusion feature through a cross modal pixel attention (CMPA) module. Then, a multi-scale pixel attention (MSPA) module may gradually restore an HR depth map based on multi-scale contextual information and pixel attention to obtain a third fusion feature. Subsequently, the features input to the MMFF and the third fusion feature may be processed (for example, merged, combined, or the like) to obtain the first fusion feature.

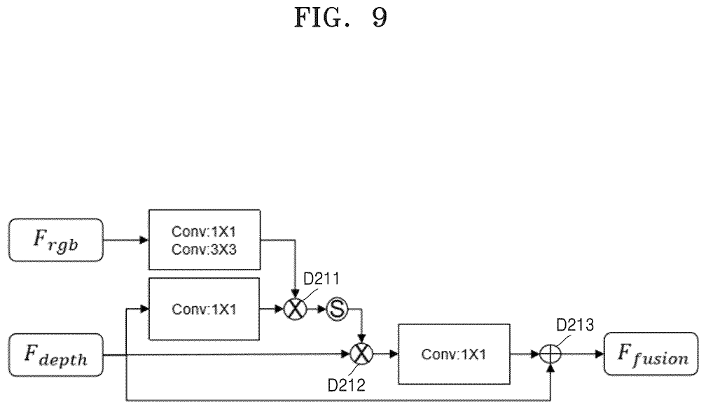

FIG. 9 is a network architecture diagram of CMPA, according to one or more embodiments of the disclosure.

In one or more embodiments, as shown in FIG. 9, the CMPA module includes a separate RGB feature input and provides cross-modal information for dept reconstruction. The CMPA may be expressed by Equation (2).

$${F}_{fusion} = {F}_{depth} + {Conv}_{1 \times 1} ( {F}_{depth} ⊗ \int ( {Conv}_{1 \times 1 , 3 \times 3} ( {F}_{rgb} ) ⊗ {Conv}_{1 \times 1} ( {F}_{depth} ) ) ) \qquad ( 2 )$$

⊗ represents a modulation operation. The processing of CMPA requires RGB features (high frequency features), and leaning cross-modal guidance through 1*1 and 3*3 convolutions. Strong output signals present in two input channels may be amplified, but weak signals in any one channel may be attenuated. These characteristics may be beneficial to refining texture regions that are unrelated to the object surface and to enhancing natural object boundaries in the depth domain.

In operation D21, feature fusion of cross-modal may be performed based on the high frequency feature output by the third network of the previous level and the depth feature output by the fourth network of the previous level to obtain the second fusion feature, which includes operation D211 to operation D213.

In operation D211, a first modulation feature may be obtained by performing feature modulation based on the high frequency feature output by the third network of the previous level and the depth feature output by the fourth network of the previous level.

The input high frequency feature may be processed through convolution layers of 1*1 and 3*3. The input depth feature may be processed through the convolution layer of 1*1, and then feature modulation may be performed on the output of at least two convolution layers to obtain the first modulation feature.

After performing the modulation operation (for example, enhancement or weakening of the particular feature), an integral image Ⓢ may be obtained to obtain feature information of the image at various scales, which may be beneficial to simplifying complex operations and rapidly obtaining image feature information to support real-time processing of an image.

In operation D212, a second modulation feature may be obtained by performing feature modulation based on the first modulation feature and the depth feature output by the fourth network of the previous level.

As shown in FIG. 9, after obtaining the first modulation feature, the second modulation feature may be obtained by performing additional modulation processing on the input depth feature and the first modulation feature.

After performing the modulation operation, more comprehensive information may also be obtained by fusing various resolutions and semantic information that feature information of various scales may have by processing through the convolution layer of 1*1.

In operation D213, the second fusion feature may be obtained based on the depth feature output by the fourth network of the previous level and the second modulation feature.

As shown in FIG. 9, an output (for example, the second fusion feature Ffusion) of the CMPA module may be obtained by performing a merging operation on the input depth feature and the second modulation feature.

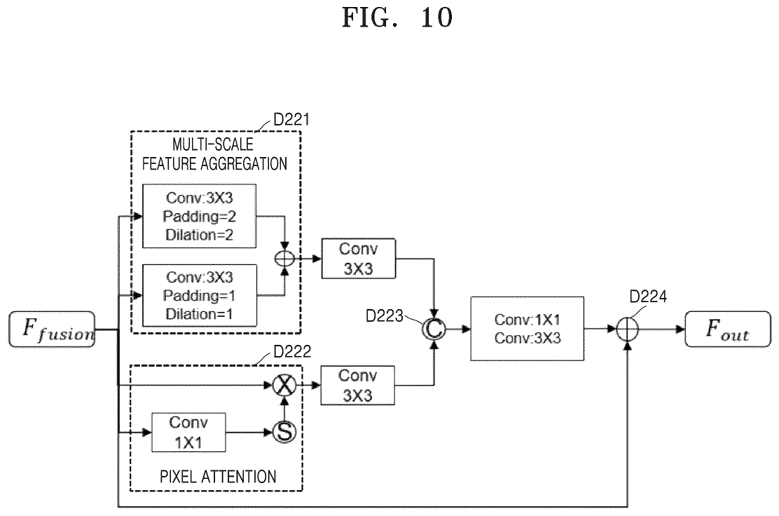

FIG. 10 is a network architecture diagram of MSPA, according to one or more embodiments of the disclosure.

In one or more embodiments, a provided MSPA module reconstructs a HR depth map based on multi-scale contextual information and pixel attention, and includes two branches including a multi-scale feature aggregation branch and a pixel attention branch, as shown in FIG. 10.

In operation D22, a third fusion feature is obtained by performing multi-scale feature fusion based on the second fusion feature, which includes operation D221 to operation D224.

In operation D221, a multi-scale fusion feature may be obtained by performing multi-scale feature processing based on the second fusion feature.

With respect to the second fusion feature output by the CMPA, multi-scale feature processing may be performed through the multi-scale feature aggregation branch, and in operation D221, the multi-scale fusion feature is obtained by performing multi-scale feature processing based on the second fusion feature, which includes operation D221a to operation D221b.

In operation D221a, based on the second fusion feature, feature extraction may be performed through two dilated convolution layers to obtain a feature corresponding to each dilated convolution layer.

The feature of each dilated convolution layer may be obtained by performing feature extraction by using each 3*3 convolution layer (for example, padding refers to a filling operation that expands the size of an input feature map by adding extra pixel values around the input, and dilation refers to a distance between convolution kernel elements that may expend a receptive region and capture a wider range of information).

In operation D221b, a multi-scale fusion feature may be obtained by merging features corresponding to respective dilated convolution layers.

To utilize contextual information from different receptive fields, outputs of respective convolution layers may be merged to obtain the multi-scale fusion feature. For example, after merging the outputs of the respective dilated convolution layers, the merged feature may also be aggregated again through one convolution layer (1*1) to obtain the multi-scale fusion feature.

In operation D222, an attention coefficient is generated for each pixel based on the second fusion feature.

The pixel attention (PA) branch may generate attention coefficients for all pixels within the feature map of the second fusion feature.

As shown in FIG. 10, a PA module may also calculate the integral of features after convolution processing, in addition to performing 1*1 convolution processing on input features, and may obtain an output of the PA module by performing a modulation operation based on an integral map and the input feature map.

In operation D223, a fusion feature related to attention may be obtained based on the multi-scale fusion feature and the attention coefficient.

Results output by two branches (for example, the multi-scale feature aggregation branch and the PA branch) may be fused through a union operation to obtain fusion features related to attention.

As shown in FIG. 10, each of the results output by the two branches may be subjected to extraction and transformation for valid features through 3*3 convolution before a fusion operation, which may perform better feature training and also improve processing efficiency.

In operation D224, the third fusion feature may be obtained based on the fusion feature related to attention and the second fusion feature.

After 1*1 convolution and 3*3 convolution are performed on the fusion feature related to attention, the MSPA module may generate an output feature Fₒᵤₜ in a residual training method.

In one or more embodiments, when multiple AI network layers (AI module) having a connection relationship, for example, an AI network layer a, an AI network layer b, an AI network layer c, . . . , and an AI network layer k, which are sequentially connected to each other, are arranged in a network structure, the previous levels of the AI network layer c may include the AI network layer a and the AI network layer b. When an output of the AI network layer a is an input of the AI network layer b, and after processing the AI network layer b, output data thereof include the output of the AI network layer a and the output of the AI network layer b itself, then the previous levels of the AI network layer c may include the AI network layer b.

Hereinafter, the effectiveness of a sequential-FoV-GDSR network according to one or more embodiments of the disclosure is described with reference to experimental data shown in Table 3 and Table 4.

For example, a model may be tested on data sets NYUv2, Middlebury 2014 HQ (for example, a dataset related to the computer vision field), and a Lu dataset with X4 ratio. Quantitative results are shown in Table 3.

TABLE 3

| | [symbol] | | | | [symbol] | | | | [symbol] | | | |
|---|---|---|---|---|---|---|---|---|---|---|---|---|
| | FIRST CENTER REGION/ | | | | FIRST CENTER REGION/ | | | | FIRST CENTER REGION/ | | | |
| | ENTIRE IMAGE | | | | ENTIRE IMAGE | | | | ENTIRE IMAGE | | | |
| METHOD | [symbol] | | DEPTH ERROR (%) | | [symbol] | | DEPTH ERROR (%) | | [symbol] | | DEPTH ERROR (%) | |
| FDSR | [symbol] | [symbol] | [symbol] | [symbol] | [symbol] | [symbol] | [symbol] | [symbol] | [symbol] | [symbol] | [symbol] | [symbol] |
| Parallel-FoV-FDSR | [symbol] | [symbol] | [symbol] | [symbol] | [symbol] | [symbol] | [symbol] | [symbol] | [symbol] | [symbol] | [symbol] | [symbol] |
| FoV-GDSR | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

Table 3 shows the quantitative evaluation results of FDSR and parallel-FoV-FDSR under the same conditions. In all three datasets, whether a foveated region or full image, it may be seen that the method according to one or more embodiments of the disclosure has reduced an RMSE by 0.01 cm (Lu) and 2.27 cm (Middlebury 2014 HQ) in the foveated region of X4 DSR compared to FDSR. In the foveated region of the NYUv2 dataset, the method according to one or more embodiments of the disclosure has a similar effect to the FDSR (for example, the accuracy of an output depth image). In addition, in Table 4, the method according to one or more embodiments of the disclosure has improved the inference speed by 21.3% on a V100 GPU compared to FDSR. In addition, as compared with the parallel-FoV-FDSR, the parameters are relatively fewer, and the execution speed is faster.

TABLE 4

| | [symbol] | | | [symbol] | | | |
|---|---|---|---|---|---|---|---|
| | | 2064*2208 | 3840*3000 | | | 2064*2208 | 3840*3000 |
| METHOD | 1280*960 | (Quest3) | (AVP) | 640*480 | 1280*960 | (Quest3) | (AVP) |
| FDSR | 57.52(100%) | [symbol] | [symbol] | 19.2(100%) | 36.5(100%) | 108.1(100%) | 209.3(100%) |
| Parallel-FoV-FDSR | 14.06 | 40.81 | 96.76 | 21.2 | 26.5 | [symbol] | 81.7 |
| FoV-GDSR | [symbol] | [symbol] | [symbol] | [symbol] | [symbol] | [symbol] | [symbol] |

[symbol]

indicates data missing or illegible when filed

As shown in Table 4, a model according to one or more embodiments of the disclosure at high resolution (2K) and super resolution (4K) has lower FLOPs and is faster compared to FDSR. For example, in case an input resolution is 2064*2208, as compared with the FDSR, the embodiment of the disclosure reduced the FLOPs from 205.93 G to 97.82 G, which is a decrease of 52.5%, and increased the inference speed from 108.1 ms to 58.6 ms, which is an improvement of 45.8%. In case an input resolution is 3840*3000, as compared with the FDSR, the method according to one or more embodiments of the disclosure reduced the FLOPs from 514.78 G to 242.44 G, which is a decrease of 53.1%, and increased the inference speed from 209.3 ms to 124.8 ms, which is an improvement of 40.4%.

Hereinafter, implementation details of the method according to one or more embodiments of the disclosure is described below.

A provided AI model takes a LR depth map D_{LR}∈R^{H×W×1}, a HR guide image G_{HR}∈R^{αH×αW×C}, and a gaze position (,) as inputs. According to the gaze position (,), feature maps of a middle periphery region (for example, a second region) and a foveated region (for example, a first region) may be obtained. The size of the middle periphery region may be set to 400*400, and the size of the foveated region may be set to 256*256.

In the training of the AI model, a L1 loss function may be used as in Equation (3).

$${L}_{1} ( \hat{D} , {D}^{GT} ) = {\sum }_{P} {‖ {D}_{p}^{GT} - {\hat{D}}_{p} ‖}_{1} \qquad ( 3 )$$

Where \hat{D} and D^{GT} represent a depth HR result and a ground truth, respectively, ∥−∥₁ computes a L1 standard, P represents a set of all pixels, and [symbol] represents one pixel in an image.

Model performance may be measured by using an RMSE, which is defined by Equation (4).

$$RMSE = \sqrt{\frac{1}{N} {\sum }_{i = 1}^{N} {( {D}_{i}^{GT} - {\hat{D}}_{i} )}^{2}} \qquad ( 4 )$$

Where

$${D}_{i}^{GT}$$

represents iₜₕ pixel value of an actual depth map, \hat{D}₁ represents iₜₕ pixel value of a super resolution depth map, and N represents a total number of pixels.

The model performance may also be measured by using a depth error, which is defined by Equation (5).

$$Depth Error = \frac{1}{N} {\sum }_{i = 1}^{N} \frac{{D}_{i}^{GT} - {\hat{D}}_{i}}{{D}_{i}^{GT}} \qquad ( 5 )$$

In one or more embodiments of the disclosure, the depth error may be implemented by using PyTorch (a deep learning framework). For example, in model training, training is performed by using a NYUv2 dataset 1. First 1000 pairs of RGB images and depth images of the dataset 1 may be used for training, and the remaining 449 pairs of data may be used for evaluation. A HR depth image may be down-sampled through bicubic, and a training sample is processed by randomly using data augmentation techniques (for example, random horizontal or vertical flips, rotations) and separate data normalization techniques. The model may be trained repeatedly for 300 times by using Adam optimization, wherein a scheduler is cosine, a decay rate is 0.5, an initial training rate is set 0.001, and decreases by 0.5 every 100 times, with a batch size of 1.

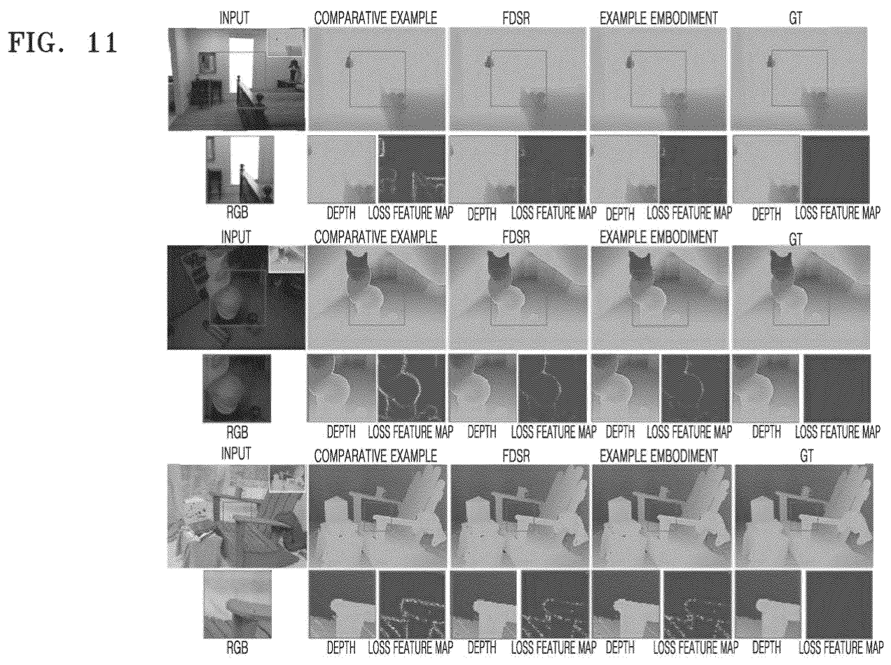

FIG. 11 is a diagram of effect comparisons according to one or more embodiments of the disclosure.

In one or more embodiments of the disclosure, FIG. 11 shows a comparison of visual effects of processing various images by using different methods. A sampling rate of an input depth map is increased several times to show a clearer difference. In FIG. 11, photos sorted from top to bottom are results of the NYUv2 dataset 1, which is sample 1; results of the Lu dataset 2, which is sample 2; and results of the Middlebury 2014 HQ dataset, which is sample 3. A ground truth (GT) represents an actual situation of each input image. By comparing depth images and error maps, it may be seen that the method according to one or more embodiments of the disclosure may effectively maintain the accuracy of output depth images while improving the processing efficiency.

In one or more embodiments, the method according to one or more embodiments of the disclosure may further include obtaining a third image including a virtual object based on the virtual object, an RGB image and a second depth image.

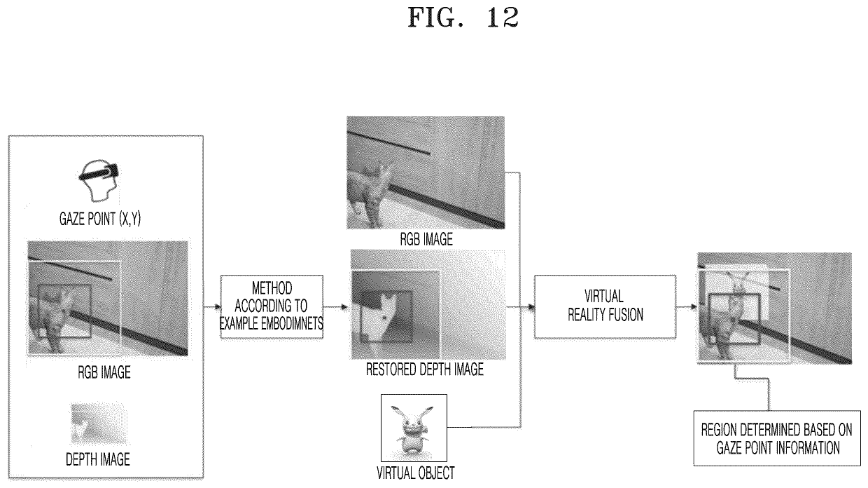

FIG. 12 is an application example diagram according to one or more embodiments of the disclosure.

As shown in FIG. 12, when obtaining an RGB image (for example, a high resolution image) and a first depth image (for example, a low resolution image) from an AR scene, a high-resolution second depth image restored through the method according to one or more embodiments of the disclosure may be obtained, and then a third image (for example, a virtual image) may be displayed by fusing (for example, virtual-reality fusion) the virtual object into the image by using depth information provided by the second depth image. For example, in the third image output by fusion, a cat may obscure a partial region of the virtual object.

The virtual object may include various virtual elements to suit the requirements of various scenes, for example, virtual equipment, virtual tools, or the like in AR games.

One or more embodiments of the disclosure may further provide an electronic device, the electronic device may include a processor and may further include a transceiver and/or a memory coupled to the processor, and the processor may be configured to execute operations of the method according to one or more embodiments of the disclosure.

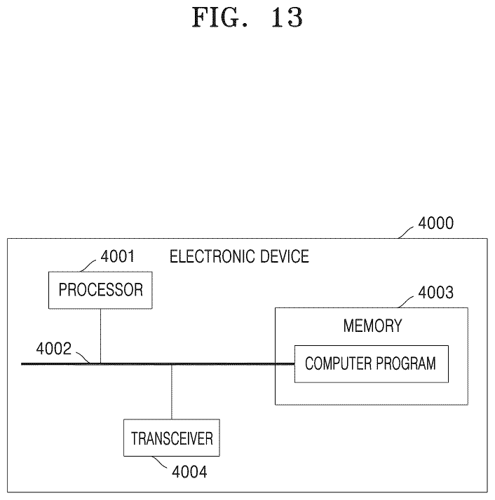

FIG. 13 is a diagram of a structure of an electronic device according to one or more embodiments of the disclosure. As shown in FIG. 13, the electronic device 4000 shown in FIG. 13 includes a processor 4001 and a memory 4003. The processor 4001 and the memory 4003 are connected to each other through, for example, a bus 4002. The electronic device 4000 may further include a transceiver 4004, and the transceiver 4004 may be used for data interaction between the electronic device 4000 and other electronic devices, for example, data transmission and/or data reception, or the like. In actual applications, the transceiver 4004 is not limited to one transceiver, and it is necessary to explain that the structure of the electronic device 4000 does not constitute a limitation to the embodiments of the disclosure. The electronic device 4000 may be at least a first node and a second node.

The processor 4001 may be a CPU, a general-purpose processor, a digital signal processor (DSP), an application-specific integrated circuit (ASIC), a field programmable gate array (FPGA) or other programmable logic device, a transistor logic device, a hardware component, or any combination thereof. This may implement or execute various example logic blocks, modules, and circuits described with reference to the disclosure content of the disclosure. The processor 4001 may also implement a combination of computing functions, and may include, for example, a combination of one or more microprocessors, a combination of a DSP and a microprocessor, or the like.

The bus 4002 may include a pathway for transmitting information between the components. The bus 4002 may be a peripheral component interconnect (PCI) bus or an extended industry standard architecture (EISA) bus, or the like. The bus 4002 may be divided into an address bus, a data bus, a control bus, or the like. For convenience of expression, the bus 4002 is shown as a single bold line in FIG. 13, but this does not mean that there is only one bus or only one type of bus.

The memory 4003 may read-only memory (ROM) or other type of static memory capable of storing static information and commands, random-access memory (RAM) or other type of dynamic storage device capable of storing information and commands, electrically erasable programmable ROM (EEPROM), compact disc ROM (CD-ROM) or other optical disk memory (such as a compressed optical disk, a laser optical disk, an optical disk, a digital universal optical disk, or a Blue-ray optical disk), a magnetic disk storage medium, other magnetic storage device, or any other medium capable of carrying or storing a computer program and readable by a computer, but is not limited thereto.

The memory 4003 stores a computer program that executes the embodiment of the disclosure, and is controlled and executed by the processor 4001. The processor 4001 executes a computer program stored in the memory 4003 to implement operations illustrated in the embodiments of the method described above.

One or more embodiments of the disclosure may provide a computer-readable storage medium, a computer program may be stored in the computer-readable storage medium, and when the computer program is executed by a processor, operations and the corresponding contents of the embodiments of the method described above may be implemented.

Various embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., CD-ROM), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

At least one of the devices, units, components, modules, units, or the like represented by a block or an equivalent indication in the above embodiments may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein).

One or more embodiments of the disclosure may provide a computer program product including a computer program, wherein when the computer program is executed by a processor, operations and the corresponding contents of the embodiments of the method described above may be implemented.

The terms “first,’ ‘second,’ ‘third,’ ‘1,’ ‘2,’ or the like (if present) in the specification, claims, and drawings of the disclosure are intended only to distinguish similar objects and are not necessarily intended to describe a particular order or sequence. It should be understood that data used in this manner is compatible with the embodiments of the disclosure described herein and that the embodiments may be practiced in a sequence other than that illustrated or described literally.

Although each operation is shown by an arrow in the flowcharts of the embodiments of the disclosure, it should be understood that the order of implementation of these operations is not limited to the order indicated by the arrows. It should be understood that in some implementation scenarios of the embodiments of the disclosure, the implementation operations of each flowchart may be executed in a different order as needed, unless otherwise specifically described in the text. In addition, some or all of the operations in each flowchart are based on actual implementation scenarios and may include a plurality of sub-operations or a plurality of operations. Some or all of these sub-operations or operations may be simultaneously executed, and each of these sub-operations or operations may be executed at different times. In scenarios where execution times are different, an execution order of these sub-operations or operations may be flexibly configured as needed, and the embodiments of the disclosure are not limited thereto.

Effects of the disclosure brought about by the technical solution provided by the embodiments of the disclosure are as follows.

One or more embodiments of the disclosure may provide an image processing method, and more particularly, when a first image is obtained, the first image may be processed based on gaze point information through an AI network to obtain at least two image regions, and a second depth image may be obtained based on the at least two image regions. The first image input to the AI network may include an RGB image and a first depth image, and the resolution of the first depth image may be lower than the resolution of the second depth image. The image quality of each image region may be different among the at least two image regions obtained by processing.

In one or more embodiments of the disclosure, because the image quality of each of the at least two image regions obtained based on the gaze point information is different, a process of obtaining a high-resolution second depth image based on the at least two image regions may reduce an amount of computation and complexity of image processing and improve the efficiency of image processing, thereby meeting the real-time requirements of image processing.

Each of the embodiments provided in the above description is not excluded from being associated with one or more features of another example or another embodiment also provided herein or not provided herein but consistent with the disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method comprising:
obtaining a first image, wherein the first image comprises an RGB image and a first depth image as components of the first image;
obtaining at least two image regions by processing the first image through an artificial intelligence (AI) network based on gaze point information; and
obtaining a second depth image based on the at least two image regions,
wherein, in the at least two image regions, image qualities of respective image regions are different, and
wherein a resolution of the first depth image is lower than a resolution of the second depth image.

2. The method of claim 1, wherein the at least two image regions comprise:
a first image region obtained based on an image feature of a first region in the first image centered on a gaze point;
a second image region obtained based on an image feature of a second region in the first image centered on the gaze point, wherein a pixel size of the second region is greater than a pixel size of the first region; and
a third image region obtained based on an image feature of the first image.

3. The method of claim 1, wherein the obtaining of the at least two image regions comprises:
obtaining a first image region by processing, through a first network, a first region in the first image that is determined based on the gaze point information; and
obtaining at least one second image region by processing, through a second network, a region in the first image other than the first region, and
wherein the second network comprises a partial network structure of the first network.

4. The method of claim 1, wherein the obtaining of the at least two image regions comprises:
obtaining a shallow feature of the first image;
obtaining at least one image region by performing feature reconstruction on the shallow feature;
obtaining, based on the shallow feature, a deep feature of a first region in the first image that is determined based on the gaze point information; and
obtaining a first image region by performing feature reconstruction on the deep feature.

5. The method of claim 4, wherein the obtaining of the at least two image regions further comprises:
obtaining a first shallow feature of the first image;
obtaining a third image region by performing feature reconstruction of the first shallow feature;
obtaining, based on the first shallow feature, a second shallow feature of a second region in the first image that is determined based on the gaze point information; and
obtaining a second image region by performing feature reconstruction on the second shallow feature, and
wherein a pixel size of the second region is greater than a pixel size of the first region.

6. The method of claim 1, wherein the AI network comprises a third network and a fourth network connected in parallel,
wherein the third network comprises:
a first network layer configured to obtain a high frequency feature within the RGB image; and
a second network layer connected to the first network layer and configured to aggregate features output by previous levels,
wherein the fourth network comprises:
a third network layer configured to fuse a depth feature of the first depth image and a high frequency feature output by the third network; and
a fourth network layer connected to the third network layer and configured to aggregate features output by previous levels, and
wherein the obtaining of the at least two image regions comprises:
obtaining, through the third network and based on the RGB image, high frequency features of at least two regions that are determined based on the gaze point information, wherein the high frequency features comprise features representing detail information and/or boundary information;
obtaining, through the fourth network, a first fusion feature corresponding to each of the at least two regions, based on depth features of the at least two regions in the first depth image that are determined based on the high frequency features and the gaze point information; and
obtaining the at least two image regions by performing feature reconstruction for the first fusion feature corresponding to each of the at least two regions.

7. The method of claim 6, wherein the obtaining of the first fusion feature comprises:
obtaining a second fusion feature by performing feature fusion, based on the high frequency features output by a previous level of the third network and the depth features output by a previous level of the fourth network;
obtaining a third fusion feature by performing multi-scale feature fusion, based on the second fusion feature; and
obtaining the first fusion feature, based on the high frequency features output by the third network of the previous level, the depth features output by the fourth network of the previous level, and the third fusion feature.

8. The method of claim 7, wherein the obtaining of the second fusion feature comprises:
obtaining a first modulation feature by performing feature modulation based on the high frequency features output by the third network of the previous level and the depth features output by the fourth network of the previous level;
obtaining a second modulation feature by performing feature modulation based on the first modulation feature and the depth features output by the fourth network of the previous level; and
obtaining the second fusion feature based on the depth features output by the fourth network of the previous level and the second modulation feature.

9. The method of claim 7, wherein the obtaining of the third fusion feature comprises:
obtaining a multi-scale fusion feature by performing multi-scale feature processing based on the second fusion feature;
generating an attention coefficient, based on the second fusion feature;
obtaining a fusion feature related to attention based on the multi-scale fusion feature and the attention coefficient; and
obtaining the third fusion feature based on the fusion feature related to attention and the second fusion feature.

10. The method of claim 9, wherein the obtaining of the multi-scale fusion feature comprises:
obtaining a feature by performing feature extraction through at least two dilated convolution layers based on the second fusion feature; and
obtaining the multi-scale fusion feature by merging features corresponding to respective dilated convolution layers.

11. The method of claim 1, further comprising:
obtaining a virtual object; and
obtaining a third image comprising the virtual object based on the RGB image and the second depth image.

12. An electronic device, comprising:
a memory storing instructions, and;
a processor,
wherein the instructions, when executed by the processor, cause the electronic device to:
obtain a first image comprising an RGB image and a first depth image as components of the first image,
obtain at least two image regions by processing the first image based on gaze point information through an artificial intelligence (AI) network, and
obtain a second depth image based on the at least two image regions,
wherein, in the at least two image regions, image qualities of respective image regions are different, and
wherein a resolution of the first depth image is lower than a resolution of the second depth image.

13. The electronic device of claim 12, wherein the at least two image regions comprise a first image region obtained based on an image feature of a first region in the first image centered on a gaze point, a second image region obtained based on an image feature of a second region in the first image centered on the gaze point, and a third image region obtained based on an image feature of the first image, and
wherein a pixel size of the second region is greater than a pixel size of the first region.

14. The electronic device of claim 12, wherein the instructions, when executed by the processor, cause the electronic device to obtain the at least two image regions by:
obtaining, through a first network, a first image region by processing a first region in the first image that is determined based on the gaze point information, and
obtaining, through a second network, at least one other image region by processing a region in the first image other than the first region, and
wherein the second network comprises a partial network structure of the first network.

15. The electronic device of claim 12, wherein the instructions, when executed by the processor, cause the electronic device to obtain the at least two image regions by:
obtaining a shallow feature of the first image,
obtaining at least one image region by performing feature reconstruction on the shallow feature,
obtaining, based on the shallow feature, a deep feature of a first region in the first image that is determined based on the gaze point information, and
obtaining a first image region by performing feature reconstruction on the deep feature.

16. The electronic device of claim 15, wherein the instructions, when executed by the processor, cause the electronic device to obtain the at least two image regions by:
obtaining a first shallow feature of the first image,
obtaining a third image region by performing feature reconstruction on the first shallow feature,
obtaining, based on the first shallow feature, a second shallow feature of a second region in the first image that is determined based on the gaze point information, and
obtaining a second image region by performing feature reconstruction on the second shallow feature, and
wherein a pixel size of the second region is greater than a pixel size of the first region.

17. The electronic device of claim 12, wherein the instructions, when executed by the processor, further cause the electronic device to:
obtain a virtual object, and
obtain a third image comprising the virtual object based on the RGB image and the second depth image.

18. A non-transitory, computer-readable storage medium storing instructions that, when executed by a processor, cause the processor to:
obtain a first image, wherein the first image comprises an RGB image and a first depth image as components of the first image;
obtain at least two image regions by processing the first image through an artificial intelligence (AI) network based on gaze point information; and
obtain a second depth image based on the at least two image regions,
wherein, in the at least two image regions, image qualities of respective image regions are different, and
wherein a resolution of the first depth image is lower than a resolution of the second depth image.

19. The storage medium of claim 18, wherein the at least two image regions comprise:
a first image region obtained based on an image feature of a first region in the first image centered on a gaze point;
a second image region obtained based on an image feature of a second region in the first image centered on the gaze point, wherein a pixel size of the second region is greater than a pixel size of the first region; and
a third image region obtained based on an image feature of the first image.

20. The storage medium of claim 18, wherein the instructions, when executed by the processor, further cause the processor to obtain the at least two image regions by:
obtaining a first image region by processing, through a first network, a first region in the first image that is determined based on the gaze point information; and
obtaining at least one second image region by processing, through a second network, a region in the first image other than the first region, and
wherein the second network comprises a partial network structure of the first network.
